(19) United States
(12) Patent Application Publication
(10) Pub. No.: US 2014/0095082 A1
(43) Pub. Date: Apr. 3, 2014

(54) EXPANDED LINEAR RANGE BY USE OF TWO FLOW CELL DETECTORS WITH LONG AND SHORT PATH

(71) Applicant: Hubert Kuderer, Waldbronn (DE)

(72) Inventor: Hubert Kuderer, Waldbronn (DE)

(73) Assignee: Agilent Technologies, Inc., Santa Clara, CA (US)

(21) Appl. No.: 14/122,451

(22) PCT Filed: May 31, 2011
(86) PCT No.: PCT/EP2011/058995

§ 371 Date: Nov. 26, 2013

(51) Int. Cl. G01N 21/59

(52) U.S. Cl. CPC G01N 21/59
USPC 702/22; 250/373; 356/440

(57) ABSTRACT

A sample detection apparatus (200) for detecting a fluidic sample flowing through a first flow cell (202) and flowing through a second flow cell (204) of a sample separation system (10), wherein the first flow cell (202) has a first path length (D) and the second flow cell (204) has a second path length (d) being smaller than the first path length (D), wherein the sample detection apparatus (200) comprises a data determining unit (206) configured for determining first data indicative of a first relation between a detection signal intensity and a concentration of the fluidic sample in the first flow cell (202), and configured for determining second data indicative of a second relation between a detection signal intensity and the concentration of the fluidic sample in the second flow cell (204), and a data combining unit (208) configured for combining the first data and the second data in accordance with a continuous weighting function to thereby derive a weighted relation between detection signal intensity and concentration of the fluidic sample so that the weighted relation continuously reduces the contribution of the first data and continuously increases the contribution of the second data with increasing concentration.

### BACKGROUND ART

The present invention relates to sample detection using flow cells.

In liquid chromatography, a fluidic analyte may be pumped through conduits and a column comprising a material which is capable of separating different components of the fluidic analyte. Such a material, so-called beads which may comprise silica gel, may be filled into a column tube which may be connected to other elements (like a control unit, containers including sample and/or buffers) by conduits. When a fluidic sample is pumped through the column tube, it is separated into different fractions. The separated fluid may be pumped in a flow cell in which the different components are identified on the basis of an optical detection mechanism.

U.S. Pat. No. 5,214,593 discloses a method and accompanying apparatus for automatically extending the linear dynamic absorbance range of absorbance detectors including multi-light path flow cells. The absorbance of a reference beam in a relatively short reference path is multiplied by a ratio of the absorbance of a sample beam in a relatively long sample path to the reference path absorbance in developing a relative absorbance for the sample path beyond its linear dynamic range.

Conventional detection cells may suffer from a limited accuracy over a sufficiently large range of concentration values of a sample to be detected.

### DISCLOSURE

It is an object of the invention to enable flow cell-based sample detection with proper detection accuracy. The object is solved by the independent claims. Further embodiments are shown by the dependent claims.

According to an exemplary embodiment of the present invention, a sample detection apparatus for detecting a fluidic sample flowing through a first flow cell and flowing through a second flow cell (which may be located upstream or downstream of the first flow cell, particularly may be in fluid communication with the first flow cell) of a sample separation system (such as a liquid chromatography apparatus) is provided, wherein the first flow cell has a first path length and the second flow cell has a second path length being smaller (or shorter) than the first path length, wherein the sample detection apparatus comprises a data determining unit (which may be a processor or part of a processor) configured for determining first data indicative of a first relation between a detection signal intensity (such as an absorption of electromagnetic radiation by the fluidic sample) and a concentration of the fluidic sample (or a fraction of the fluidic sample) in the first flow cell, and configured for determining second data indicative of a second relation between a detection signal intensity and the concentration of the fluidic sample in the second flow cell, and a data combining unit (which may be a processor or part of a processor) configured for combining (for instance adding variable contributions of) the first data and the second data in accordance with a continuous weighting function to thereby derive a weighted relation between detection signal intensity (i.e. an effective or a weighted detection signal intensity) and concentration of the fluidic sample so that the weighted relation continuously reduces the contribution of the first data and continuously increases the contribution of the second data with increasing concentration (in other words, the weighted relation may weight the contribution of the first flow cell with the longer flow cell strongly at small concentration values of the detected fluidic sample and weaker at larger concentration values of the detected fluidic sample; correspondingly, the weighted relation may weight the contribution of the second flow cell with the shorter flow cell strongly at high concentration values of the detected fluidic sample and weaker at smaller concentration values of the detected fluidic sample).

According to another exemplary embodiment, a sample separation system for separating components of a fluidic sample is provided, the sample separation system comprising a separation unit (such as a chromatographic column) configured for separating the fluidic sample into the components, a first flow cell in fluid communication with the separation unit for receiving the separated sample fluid from the separation unit, wherein the first flow cell has a first path length, a second flow cell in fluid communication with the separation unit for receiving the separated sample fluid from the separation unit, wherein the second flow cell has a second path length being smaller than the first path length, and a sample detection apparatus having the above mentioned features configured for detecting the separated components.

According to still another exemplary embodiment, a method of detecting a fluidic sample flowing through a first flow cell and flowing through a second flow cell of a sample separation system is provided, wherein the first flow cell has a first path length and the second flow cell has a second path length being smaller than the first path length, wherein the method comprises determining first data indicative of a first relation between a detection signal intensity and a concentration of the fluidic sample in the first flow cell, determining second data indicative of a second relation between a detection signal intensity and the concentration of the fluidic sample in the second flow cell, and combining the first data and the second data in accordance with a continuous weighting function to thereby derive a weighted relation between detection signal intensity and concentration of the fluidic sample so that the weighted relation continuously reduces the contribution of the first data and continuously increases the contribution of the second data with increasing concentration.

According to still another exemplary embodiment of the present invention, a software program or product is provided, preferably stored on a data carrier, for controlling or executing the method having the above mentioned features, when run on a data processing system (which may include the data determining unit and the data combining unit) such as a computer.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in the context of measurement data analysis. The measurement data analysis scheme according to an embodiment of the invention can be performed or assisted by a computer program, i.e. by software, or by using one or more special electronic optimization circuits, i.e. in hardware, or in hybrid form, i.e. by means of software components and hardware components.

In the context of this application, the term “flow cell” may particularly denote a fluidic channel delimited by a tubing through which a fluidic sample, which may already be separated, can flow. In the flow cell, electromagnetic radiation may be introduced, and subsequently the fluidic sample may be characterized by detecting the absorption of the electromagnetic radiation by the fluidic sample, or by detecting fluorescence radiation emitted by the fluidic sample upon being excited with primary electromagnetic radiation.

The term “path length” may particularly denote a physical length, i.e. a shortest distance, between an electromagnetic radiation inlet interface and an electromagnetic radiation outlet interface of a respective flow cell between which the electromagnetic radiation propagates for interaction with the fluidic sample conducted through the respective flow cell. Along the length of this path, interaction between the fluidic sample and electromagnetic radiation may be enabled. The term “path length” may more specifically denote the shortest distance between a light inlet interface (for instance a fiber end of a light inlet fiber) and a light outlet interface (for instance a fiber begin of light outlet fiber) of a flow cell.

The term “electromagnetic radiation” may particularly denote an ensemble of photons. The electromagnetic radiation may be, for instance, in the range of visible light, ultraviolet radiation, or infrared radiation. Primary electromagnetic radiation irradiated onto the fluidic sample and secondary electromagnetic radiation received from the fluidic sample in response to the primary electromagnetic radiation may or may not differ regarding wavelengths. Such primary electromagnetic radiation and such secondary electromagnetic radiation may be monochromatic or polychromatic.

The term “relation between detection signal intensity and concentration of the fluidic sample” may particularly denote a characteristic interdependency of these two parameters. In other words, a certain value of the detection signal intensity such as absorbance (for instance integrated over a peak) may be correlated to a certain value of a concentration of a fraction of the fluidic sample corresponding to this peak. According to the Lambert Beer Law, the intensity of a detection signal, particularly an absorbance, and a concentration of a fluidic sample (for instance a certain fraction of molecules) within a mobile phase may be linear in the absence of artifacts. However, the relation between raw detection signal intensity and concentration of the fluidic sample may still include such artifacts.

The term “weighting function” may particularly denote a function according to which contributions of measurement-related data of the two flow cells are combined to derive a result. For instance, the weighting function may define that the measurement signal from the first flow cell will be taken into account by X % and the measurement signal from the second flow cell will be taken into account by (100−X) %, wherein X may vary with varying absorbance (and consequently concentration) values.

The term “continuous weighting function” may particularly denote a weighting function for which small changes in the input result in small changes in the output, particularly a function being free of discontinuous sections in which a value of the function jumps. In other words, a continuous function provides for a smooth transition of a value. In the context of the application, the weighting function is continuous and describes a contribution taken from a relation between detection signal intensity and fluidic sample concentration at two different flow cells which are to be combined with one another. In order to obtain a physical meaningful weighting function free of artifacts, the transition between the contribution of both flow cells is smooth as a result of the continuous weighting function.

According to an exemplary embodiment of the invention, the linear range of a flow cell arrangement, particularly of a liquid chromatography device, is expanded by the use of two flow cells (which may be fluidically coupled in series) and hence two detectors, wherein the different flow cells have a different length. The use of two flow cells having different lengths relates to the fact that a sub-range of concentration values of a fluidic sample in which a detection signal intensity of a corresponding flow cell shows artifacts due to noise is higher for a short flow cell as compared to a long flow cell. On the other hand, saturation effects at high concentration values according to which the linearity of the detection signal intensity is disturbed relates to the effect that a majority of the use light is absorbed by the sample and some not properly absorbable light propagates through the flow cell basically without interaction with the fluidic sample. This artifact may occur to a significant extent already at lower concentration values in a long flow cell as compared to a short flow cell. An embodiment of the invention now considers the two effects and uses the detection signal intensity versus concentration characteristics derivable from the measurement data obtained from the two flow cells in such a manner that the selective strengths and weaknesses of both flow cells are considered. This is reflected by considering the contributions from the long flow cell and the short flow cell in accordance with a continuous weighting function which exclusively or predominantly uses the contribution of the longer flow cell at relatively small concentration values, uses exclusively or predominantly contributions from the short flow cell at relatively high concentration values and provides for a smooth transition in an intermediate range between these high and low concentration values. By modeling the weighting function under consideration of the above-mentioned physical boundary conditions and at the same time requiring the weighting function to be always continuous over the entire range of concentration values allows to suppress artifacts and to obtain a broad quasi-linear range in which the derived correlation between weighted detection signal intensity and concentration of the fluidic sample provides highly precise results.

In the following, further exemplary embodiments of the sample detection apparatus will be explained. However, these embodiments also apply to the sample separation system, the method, and the software program or product.

In an embodiment, the data combining unit is configured for combining the first data and the second data in accordance with a continuous differentiable weighting function. In such a preferred embodiment, the weighting function defining the individual contributions of the long flow cell and the short flow cell is not only a continuous function, but is also continuously differentiable over the whole range of concentration values. In this context, the term differentiable means that not only the weighting function itself but also the first derivative of the weighting function with regard to the concentration is continuous. It has turned out that not only rendering the weighting function continuous, but also differentiable further improves the meaningfulness of the derived data.

In an embodiment, the data combining unit is configured for combining the first data and the second data to derive the weighted relation by exclusively using the first data and disregarding the second data below a lower threshold value of the detection signal intensity (which may be particularly an absorbance value, for instance integrated over a peak), exclusively using the second data and disregarding the first data above an upper threshold value being larger than the lower threshold value of the detection signal intensity, using both the first data and the second data in accordance with the weighting function between the lower threshold value and the upper threshold value, so that the weighted relation is continuous, particularly shows a smooth transition, both at the lower threshold value and at the upper threshold value. It should be said here that the absorbance is also indicative of the concentration of the detected fraction of the fluidic sample (the more molecules in this fraction, the stronger the absorbance). This preferred embodiment is based on the cognition that the long flow cell has particularly strength and shows a proper linearity already at quite small concentration values (and correspondingly small absorbance values), at which the short flow cell still suffers from noise, whereas at very high concentration values (and correspondingly high absorbance values) the short flow cell has a proper linear behavior while the long flow cell already suffers from saturation-based artifacts. Therefore, only the detection signal intensity of the long flow cell is used at small concentration/absorbance values up to a lower threshold value, and only the contribution of the short flow cell is used above another upper threshold value of concentration/absorbance. However, in a region between these two threshold values in which both flow cells provide an acceptable linearity, absorbance-dependent (and hence concentration-dependent) contributions of the flow cells are selected under consideration of the condition that at both the lower threshold value and the upper threshold value the weighting function shows a smooth transition. More preferable, the weighting function is also differentiable particularly at these values, i.e. the lower and the upper threshold value.

In an embodiment, the data determining unit is configured for determining the respective data based on a measurement signal received from the respective flow cell, the measurement signal being indicative of a relation between detection signal intensity and measurement time. The measurement signal can be a relation between detection signal intensity (such as an absorbance in case of an electromagnetic radiation based absorption measurement) and the measurement time. A detector will detect peaks of absorbance when a fluidic sample passes the detector which has molecules strongly absorbing the electromagnetic radiation (or having fluorescence labels attached thereto). Therefore, a value of signal intensity can be measured over time. A time where such a peak has a maximum can also be denoted as a retention time in terms of liquid chromatography. Integrating over such a peak may then allow to obtain the above-mentioned relation between detecting signal intensity and concentration of the fluidic sample.

In an embodiment, the data determining unit is configured for determining the respective data based on secondary electromagnetic radiation measured from the fluidic sample in response to the irradiation of the fluidic sample with primary electromagnetic radiation, the measured secondary electromagnetic radiation constituting the measurement signal received from the respective flow cell. In such an embodiment, an electromagnetic radiation source emits electromagnetic radiation onto the fluidic sample passing along the flow cell. This so-called primary electromagnetic radiation can interact with the fluidic sample (for instance the fluidic sample can absorb specific wavelengths from this primary electromagnetic radiation). Hence, so-called secondary electromagnetic radiation which can be detected after interaction of the primary electromagnetic radiation with the sample is generated and can be used as a fingerprint of the fluidic sample to be detected.

In an embodiment, the data determining unit is configured for determining the respective data individually for different measurement wavelengths of the secondary electromagnetic radiation. Correspondingly, the data combining unit is configured for combining the first data and the second data in accordance with a wavelength-dependent weighting function being different for different measurement wavelengths of the secondary electromagnetic radiation. In this preferred embodiment, polychromatic electromagnetic radiation, i.e. primary electromagnetic radiation having different wavelengths, is emitted onto the fluidic sample. Thus, multi-wavelength measurements may be carried out at the same time. The contributions from the different wavelengths can be separated from the secondary electromagnetic radiation by directing it onto a grating or any other wavelengths selective member so that the ensemble of wavelengths can be spatially spread along a detector, which may for instance be a linear array of photocells. Therefore, the measurement may be performed at the same time for multiple wavelengths significantly increasing the meaningfulness of the detected results. However, since the relation between detection signal intensity and concentration also depends on the wavelength, a separate weighting function may be used for each wavelength or, in other terms, the wavelength may be parameter on which the weighting function depends.

In an embodiment, the data determining unit is configured for adding a delay selectively to the measurement signal of the first flow cell (when being arranged upstream of the second flow cell) for at least partially compensating a measurement signal delay in the second flow cell as compared to the first flow cell. Additionally or alternatively, a delay may be subtracted selectively from the measurement signal of the second flow cell for at least partially compensating a measurement signal delay. By taking this measure, an artifact can be compensated that the fluidic sample having first passed the first flow cell and then flowing towards the second flow cell arrives with temporal delay at the second flow cell as compared to the first flow cell. In order to make the measurement signals of the two flow cells directly comparable, the delay may modeled so that the peaks detected by the first flow cell may be shifted towards later times in order to compensate such a delay. Alternatively, the signal of the second flow cell may be shifted to earlier times.

In an embodiment, the data determining unit is configured for adding the selective delay in accordance with the flow rate of the fluidic sample. The flow rate can be measured by a pressure sensor or by a flow rate sensor arranged along the fluidic path. The flow rate may be denoted as the flowing fluid volume per time interval. If this flow rate is known, the delay time between the first flow cell and the second flow cell can be calculated and can then be compensated.

In an embodiment, the data determining unit is configured for selectively broadening only the measurement signal of the first flow cell (when being arranged upstream of the second flow cell) for at least partially compensating a measurement signal broadening in the second flow cell as compared to the first flow cell. Additionally or alternatively, the data determining unit may be configured for selectively narrowing only the measurement signal of the second flow cell for at least partially compensating a measurement signal broadening in the second flow cell as compared to the first flow cell. As a consequence of physical processes occurring during the flow of the fluidic sample along a fluidic path, broadening of the peaks may occur. In other words, the full width half maximum of the peaks may be increased while the fluidic sample flows through the entire flow path. Therefore, in order to make the detection signal intensities directly comparable between the different flow cells, the additional broadening detected at the (downstream) second flow cell should be taken into account.

In an embodiment, the data determining unit comprises a filter, particularly an infinite impulse response filter, for performing the selective broadening. Generally, any appropriate filter may be used to simulate such a broadening. However, it has turned out to be particularly precise and simple to use an infinite impulse response filter (IIR filter). IIR filters may have an impulse response function that is non-zero over an infinite length of time. It has turned out that such a filter properly simulates the broadening effect of a flowing fluidic sample.

In an embodiment, the data determining unit is configured for scaling the measurement signals (along a signal intensity axis) of the first flow cell and the second flow cell relative to one another for at least partially compensating the different path lengths in the first flow cell and the second flow cell. The absolute dependency between an absorption signal and a concentration value depends on the length of the flow cell because in a longer cell more absorption is possible than in a shorter cell due to the larger interaction time between fluidic sample and electromagnetic radiation. In order to make the signals of the flow cells of different lengths direct comparable, a rescaling of at least one of the two signals is advantageous.

In an embodiment, the data determining unit is configured for scaling the measurement signals of the first flow cell and the second flow cell relative to one another by normalizing the measurement signals to a normalized path length which may be defined as a standard. For example, a normalized path length may be 1 cm. The first flow cell which may have a flow path larger than 1 cm (or more generally larger than the normalized path length), may then be downscaled to this shorter length. Correspondingly, the second flow cell, which may have a flow path shorter than the normalized path length may be expanded or upscaled. By normalizing the signals from the different flow cells to a normalized path length, it is possible to make different detection signals of different flow cells directly comparable to one another.

In an embodiment, the data determining unit is configured for performing a baseline correction for at least partially removing signal underground in the measurement signals of the first flow cell and the second flow cell. Due to impurities in the fluidic sample and other effects, some additional non-characteristic signal may be overlaid to the measurement signals. Such an unspecific signal may be removed at least partially before combining the measurement signal of the first and the second flow cell to further increase accuracy.

In an embodiment, the data determining unit is configured for performing the baseline correction by determining and subtracting a for instance linear function from the measurement signals of the first and the second flow cell for modeling signal underground. It has turned out that a linear function, i.e. a function y=ax+t, is for many impurities a proper approximation for the contribution of the unspecific signal underground and does not involve too much computational burden to the data analysis system. However, other functions, such as a polynomial function, are possible as well for modeling the signal underground.

In an embodiment, the detection signal intensity is indicative of an absorption (or absorbance) of electromagnetic radiation, propagating along the respective flow cell over the respective path length, by the fluidic sample. The term “absorption” may denote the reduction of signal intensity of primary electromagnetic radiation by interaction with the fluidic sample. However, in contrast to absorption measurements, it is also possible to perform transition measurements, fluorescence measurements or the like.

In an embodiment, the respective data may be indicative of a respective relation between the respective detection signal intensity, divided by the concentration of the fluidic sample, and the concentration of the fluidic sample in the respective flow cell. In accordance with the Lambert Beer Rule, a detection signal intensity of a flow cell (more precisely the absorbance) is a linear function of the concentration of the fluidic sample. However, by dividing this detection signal intensity by the concentration, a constant function can be obtained in the absence of artifacts. However, due to noise at low concentration values and due to saturation effects at high concentration values a deviation of such a constant function can occur.

In an embodiment, the sample detection apparatus is further configured for detecting the fluidic sample flowing through a third flow cell which has a third path length differing from the first path length and the second path length, wherein the data determining unit is configured for determining third data indicative of a third relation between a detection signal intensity and the concentration of the fluidic sample in the third flow cell, and wherein the data combining unit is configured for combining the first data and the second data and the third data in accordance with the continuous weighting function. Hence, it is possible to add a third flow cell (and, if desired, even more flow cells) to further refine and extend the linear range. The combination of the individual signals of these more than two flow cells may then be estimated in a corresponding manner as described above. In other words, the data determining unit and the data combining unit may be adapted for combining at least three contributions in a corresponding way as described herein.

In an embodiment, the weighting function is selected under consideration of the boundary condition that noise-based artifacts occur (to a significant extent, i.e. to an extent being larger than a predetermined noise threshold value) in the first flow cell only at lower concentrations than in the second flow cell. It is considered that this effect results from the fact that a sufficient statistical basis for a linear behavior does not exist with sufficient accuracy at very low concentration values, however depending on the length of the respective flow cell.

In an embodiment, the weighting function is selected under consideration of the boundary condition that saturation-based artifacts resulting from stray radiation (such as stray light) occur (to a significant extent, i.e. to an extent being larger than a predetermined saturation threshold value) in the first flow cell already at lower concentrations than in the second flow cell. It is believed that this effect occurs if most of the usable light is already absorbed in the flow cell, so that this effect occurs already at lower concentration values in the longer flow cell.

In an embodiment, the first path length and the second path length are selected so that a range of concentration values of the fluidic sample over which the first flow cell shows a linear relation between a detection signal intensity and a concentration of the fluidic sample overlaps with a range of concentration values of the fluidic sample over which the second flow cell shows a linear relation between a detection signal intensity and a concentration of the fluidic sample. Hence, for a user, the multiple flow cell arrangement according to an exemplary embodiment effectively appears as a liquid chromatography apparatus having an extremely long range of linear behavior.

In an embodiment, the weighting function has a contribution for the first flow cell of exp (−A/ξ)^{K} and has a contribution for the second flow cell of 1-exp (−A/ξ)^{K}, wherein A is the nominal absorbance, ξ defines an absorbance value at which the contribution of the first flow cell equals to the contribution of the second flow cell, and κ is a parameter which defines a slope of the weighting function. It has turned out that a corresponding weighting function results in an artifact-free combination of the two signal contributions.

In the following, further exemplary embodiments of the sample separation system will be explained. However, these embodiments also apply to the sample detection apparatus, the method, and the software program or product.

In an embodiment, the second flow cell is arranged downstream of and in fluid communication with the first flow cell for receiving the separated sample fluid from the first flow cell. In other words, the fluidic sample will then first pass the first flow cell and will only subsequently pass the serially connected second flow cell.

In an embodiment, the first path length is larger than about 15 mm and the second path length is smaller than about 8 mm. In an embodiment, the first path length is in a range between about 10 mm and about 100 mm, particularly in a range between about 30 mm and about 80 mm. In an embodiment, the second path length is in a range between about 1 mm and about 9 mm, particularly in a range between about 2 mm and about 5 mm. It has turned out that these lengths of the flow cells are appropriate in order to allow to assemble the linear sub-ranges of the two flow cells. For example, as compared to a standard flow cell, exemplary embodiments of the invention may increase the length of the larger flow cell by a factor of 6, whereas the length of the shorter flow cell may be reduced by a factor of 3.

In an embodiment, the sample separation system comprises an electromagnetic radiation source for each of the first and the second flow cell, the electromagnetic radiation source being configured for generating primary electromagnetic radiation for irradiating the fluidic sample in the respective flow cell. The electromagnetic radiation source may be configured for generating one of an optical light beam, an ultraviolet beam and an infrared light beam as primary electromagnetic radiation for irradiating the fluidic sample in the respective flow cell. The electromagnetic radiation source may be configured for generating polychromatic primary electromagnetic radiation for irradiating the fluidic sample in the respective flow cell. The electromagnetic radiation source may be configured as one of the group consisting of a deuterium lamp, a xenon lamp, and a tungsten lamp.

In an embodiment, the sample separation system comprises an electromagnetic radiation detector for each of the first and the second flow cell, wherein the electromagnetic radiation detector comprises one of an optical light detector, and an ultraviolet radiation detector. The electromagnetic radiation detector may comprise one of a single detection element, a linear array of detection elements, and a two-dimensional array of detection elements. The electromagnetic radiation detector may comprise an electromagnetic radiation sensitive unit and a grating between the flow path of the fluidic sample and the electromagnetic radiation sensitive unit.

In an embodiment, each of the first and the second flow cell is configured as a total internal reflection (TIR) flow cell. More particularly, a tubing may be provided through which the fluidic sample flows in the respective flow cell. An electromagnetic radiation source irradiating the fluidic sample flowing in the respective flow cell may be arranged and configured, together with the tubing, for effecting a total reflection of the electromagnetic radiation at an outer wall of the tubing. The transmission through a total internal reflection flow cell is basically independent of the length of the flow cell because basically no electromagnetic radiation may escape from a total internal reflection flow cell. Therefore, a TIR flow cell provides a proper basis for extending the linear range of the detection signals as compared to a normal flow cell. Hence, it is preferred to use a TIR flow cell according to exemplary embodiments because the overlapping of the linear sub-ranges of the individual flow cells may be particularly pronounced in such kind of flow cell.

The sample separation system may comprise a separation element filled with a separating material. Such a separating material which may also be denoted as a stationary phase may be any material which allows an adjustable degree of interaction with a fluidic sample so as to be capable of separating different components of such a fluidic sample. The separation element may be arranged in a fluidic path upstream the detectors so that fractions of a sample separated by the separation element may be subsequently detected by the detector devices.

The separating material may be a liquid chromatography column filling material or packing material comprising at least one of the group consisting of polystyrene, zeolite, polyvinylalcohol, polytetrafluorethylene, glass, polymeric powder, silicon dioxide, and silica gel, or any of above with chemically modified (coated, capped etc) surface. However, any packing material can be used which has material properties allowing an analyte passing through this material to be separated into different components, for instance due to different kinds of interactions or affinities between the packing material and fractions of the analyte.

At least a part of the separation element may be filled with a fluid separating material, wherein the fluid separating material may comprise beads having a size in the range of essentially 1 μm to essentially 50 μm. Thus, these beads may be small particles which may be filled inside the separation section of the microsample separation system. The beads may have pores having a size in the range of essentially 0.01 μm to essentially 0.2 μm. The fluidic sample may be passed through the pores, wherein an interaction may occur between the fluidic sample and the pores.

The sample separation system may be configured as a fluid separation system for separating components of the sample. When a mobile phase including a fluidic sample passes through the sample separation system, for instance with a high pressure, the interaction between a filling of the column and the fluidic sample may allow for separating different components of the sample, as performed in a liquid chromatography device.

However, the sample separation system may also be configured as a fluid purification system for purifying the fluidic sample. By spatially separating different fractions of the fluidic sample, a multi-component sample may be purified, for instance a protein solution. When a protein solution has been prepared in a biochemical lab, it may still comprise a plurality of components. If, for instance, only a single protein of this multi-component liquid is of interest, the sample may be forced to pass the column. Due to the different interaction of the different protein fractions with the filling of the column (for instance using a liquid chromatography device), the different samples may be distinguished, and one sample or band of material may be selectively isolated as a purified sample. The detectors may then serve for controlling the success of the purification.

The sample separation system may be configured to conduct the mobile phase through the system with a high pressure, for instance of 50 bar to 100 bar, particularly of at least 600 bar, more particularly of at least 1200 bar.

The sample separation system may be configured as a microsample separation system. The term “microsample separation system” may particularly denote a sample separation system as described herein which allows to convey fluid through microchannels having a dimension in the order of magnitude of less than 500 μm, particularly less than 200 μm, more particularly less than 100 μm or less than 50 μm or less.

Exemplary embodiments might be embodied based on most conventionally available HPLC systems, such as the Agilent 1200 Series Rapid Resolution LC system or the Agilent 1100 HPLC series (both provided by the applicant Agilent Technologies—see www.agilent.com—which shall be incorporated herein by reference).

The separating device preferably comprises a chromatographic column (see for example http://en.wikipedia.org/wiki/Column_chromatography) providing the stationary phase. The column might be a glass or steel tube (for example with a diameter from 50 μm to 5 mm and a length of 1 cm to 1 m) or a microfluidic column (as disclosed for example in EP 1577012 or the Agilent 1200 Series HPLC-Chip/MS System provided by the applicant Agilent Technologies, see for example http://www.chem.agilent.com/Scripts/PDS.asp?IPage=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a fluidized bed is used.

The mobile phase (or eluent) can be either a pure solvent or a mixture of different solvents. It can be chosen for example to minimize the retention of the compounds of interest and/or the amount of mobile phase to run the chromatography. The mobile phase can also been chosen so that the different compounds can be separated effectively. The mobile phase might comprise an organic solvent like for example methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The fluidic sample might comprise any type of process liquid, natural sample like juice, body fluids like plasma or it may be the result of a reaction like from a fermentation broth.

The HPLC system might comprise a sampling unit for introducing the fluidic sample into the mobile phase stream, a detector for detecting separated compounds of the fluidic sample, a fractionating unit for outputting separated compounds of the fluidic sample, or any combination thereof.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a sample separation system in accordance with embodiments of the present invention, for example used in high performance liquid chromatography (HPLC).

FIG. 2 illustrates a sample detection apparatus for detecting a fluidic sample flowing through two different flow cells according to an exemplary embodiment of the invention.

FIG. 3 is a diagram showing a dependency between an absorbance and a concentration for a flow cell.

FIG. 4 is a diagram showing a dependency between an absorbance, normalized to the concentration, and the concentration of a flow cell.

FIG. 5 shows a diagram similar to FIG. 4 for a short flow cell and

FIG. 6 shows a diagram similar to FIG. 4 for a long flow cell indicating that the linear operation ranges of the flow cells overlap and depend on the length of the flow path.

FIG. 7 schematically illustrates diagrams showing the dependency of the absorbance from the measurement time and indicating that the difference in signal characteristic between a short flow cell and a long flow cell depends on whether the short flow cell is arranged upstream or downstream of the long flow cell.

FIG. 8 is a block diagram illustrating functionality of a data determining unit and a data combining unit of a sample detection apparatus for deriving concentration information from measurement data according to an exemplary embodiment of the invention.

FIG. 9 shows a diagram schematically illustrating a continuous weighting function according to an exemplary embodiment of the invention.

FIG. 10 is a diagram illustrating an absorbance characteristic (log-log scale) of fluidic sample flowing through a flow cell.

FIG. 11 shows a diagram plotting a transition range of combining two signals of different flow cells, and another diagram showing the transition range zoomed in.

FIG. 12 shows a diagram plotting a weighting function for combining signals from two flow paths of different lengths relating to two flow cells.

FIG. 13 illustrates a calculation rule for combining signals from two flow paths using a weighting function according to an exemplary embodiment of the invention.

FIG. 14 shows a diagram illustrating normalized signals of two flow cells of different lengths.

FIG. 15 illustrates a calculation rule for determining a coefficient of a weighting function according to an exemplary embodiment of the invention.

FIG. 16 shows a diagram illustrating a coefficient of a weighting function for combining signals from two flow paths depending on the absorbance.

FIG. 17 shows another curve similar to FIG. 16.

FIG. 18 shows a measurement signal indicating an absorbance over time.

FIG. 19 illustrates a measured signal over time as well as a combined signal over time in which a baseline correction is applied.

FIG. 20 illustrates a calculation rule for determining a combined signal under consideration of a baseline correction.

FIG. 21 illustrates diagrams showing a dependency between wavelength and absorbance in a spectra over peak illustration (left) and in a normalized spectra over peak illustration (right).

FIG. 22 shows diagrams similar to FIG. 21.

FIG. 23 shows a calculation rule for calculating a result matrix defined over time and wavelength.

The illustration in the drawing is schematically.

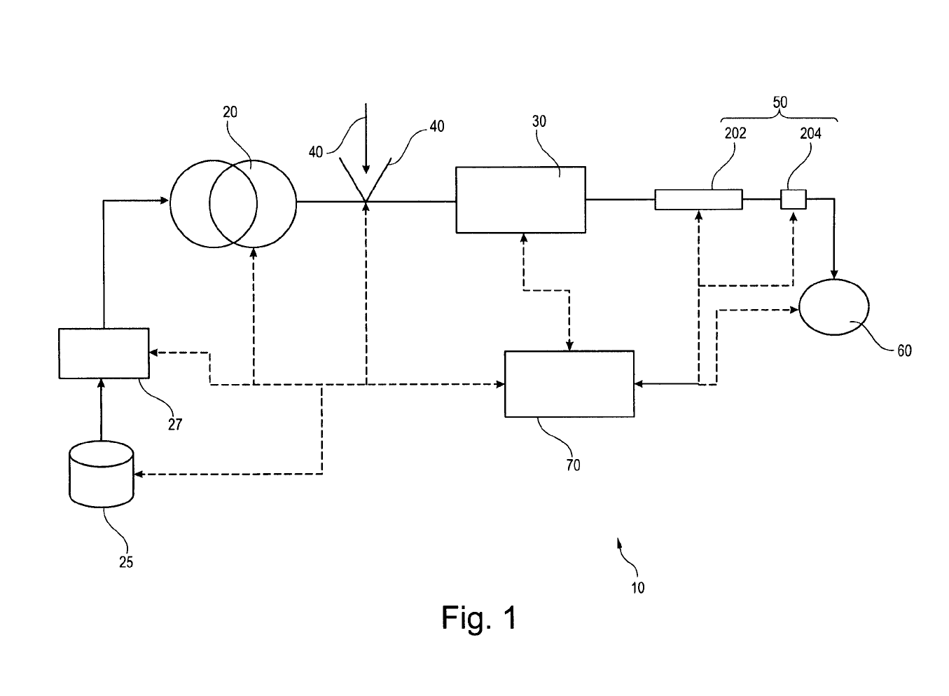

Referring now in greater detail to the drawings, FIG. 1 depicts a general schematic of a liquid separation system 10 as a sample separation system in accordance with an embodiment of the present invention. A pump 20 receives a mobile phase from a solvent supply 25, typically via a degasser 27, which degases and thus reduces the amount of dissolved gases in the mobile phase. The pump 20—as a mobile phase drive—drives the mobile phase through a separating device 30 (such as a chromatographic column) comprising a stationary phase. A sampling unit 40 can be provided between the pump 20 and the separating device 30 in order to subject or add (often referred to as sample introduction) a fluidic sample into the mobile phase. The stationary phase of the separating device 30 is configured for separating compounds of the sample liquid. A detector 50 is provided for detecting separated compounds of the sample fluid. A fractionating unit 60 can be provided for outputting separated compounds of sample fluid.

The detector 50 is illustrated in FIG. 1 in a schematic way only. However, the below described figures will provide details as to how such a detector can be configured according to exemplary embodiments. The described detector 50 comprises a first flow cell 202 and a second flow cell 204, the latter having a shorter flow path than the former.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the components in the liquid separation system 10 in order to receive information and/or control operation. For example, the data processing unit 70 might control operation of the pump 20 (for example setting control parameters) and receive therefrom information regarding the actual working conditions (such as output pressure, flow rate, etc. at an outlet of the pump). The data processing unit 70 might also control operation of the solvent supply 25 (for example setting the solvent/s or solvent mixture to be supplied) and/or the degasser 27 (for example setting control parameters such as vacuum level) and might receive therefrom information regarding the actual working conditions (such as solvent composition supplied over time, flow rate, vacuum level, etc.). The data processing unit 70 might further control operation of the sampling unit 40 (for example controlling sample injection or synchronization sample injection with operating conditions of the pump 20). The separating device 30 might also be controlled by the data processing unit 70 (for example selecting a specific flow path or column, setting operation temperature, etc.), and send—in return—information (for example operating conditions) to the data processing unit 70. Accordingly, the detector 50 might be controlled by the data processing unit 70 (for example with respect to spectral or wavelength settings, setting time constants, start/stop data acquisition), and send information (for example about the detected sample compounds) to the data processing unit 70. The data processing unit 70 might also control operation of the fractionating unit 60 (for example in conjunction with data received from the detector 50) and provides data back.

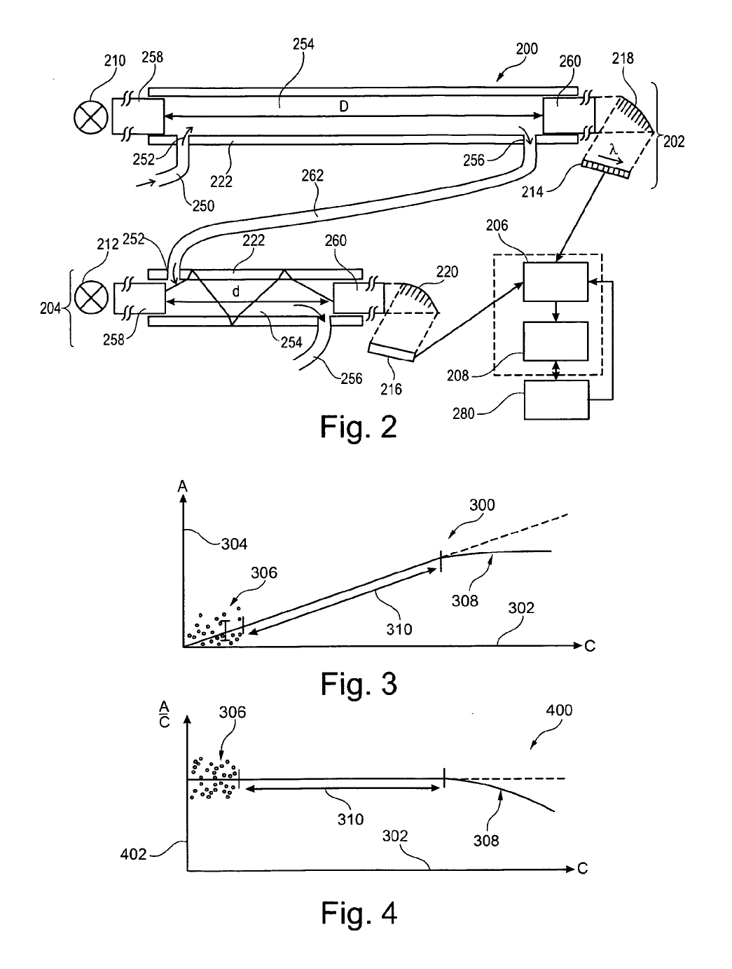

As can further be taken from FIG. 1, the detector 50 comprises the two different flow cells 202, 204 which are indicated only schematically in FIG. 1 and described in more detail referring to FIG. 2. However, already from FIG. 1 it can be taken that the first flow cell 202 has a length which is larger than the length of the second flow cell 204 of the detector 50.

In the following, referring to FIG. 2, a sample detection apparatus 200 according to an exemplary embodiment of the invention will be explained. Simply speaking, the sample detection apparatus 200 relates to a combination of reference numerals 50 and 70 in FIG. 1.

As indicated schematically in FIG. 2, a fluidic sample which has been separated in a chromatographic column (see reference numeral 30 in FIG. 1) flows through a conduit 250 via an orifice in tubing 222 to a fluid inlet port 252 of the first flow cell 202. The first flow cell 202 defines a tubular lumen 254 through which the fluidic sample can flow before leaving through another orifice in tubing 222 through a fluid outlet interface 256 of the first flow cell 202. Hence, the length of the flow path of the first flow cell 202 is D, as indicated in FIG. 2.

For detecting a certain fraction of a fluidic sample, a Deuterium lamp as a light source 210 emits light and couples this light via an inlet waveguide (such as an optical fiber) 258 into the tubular lumen 254. While the fluid flows between the fluid inlet interface 252 and the fluid outlet interface 256 interaction between the fluidic sample and the light generated by the light source 210 takes place. Such an interaction between light from the light source 210 and the fluidic sample may include partial absorbance of the light in a wavelength dependent way. The correspondingly generated secondary light (i.e. light transmitted through and/or generated by the fluidic sample) is guided via an outlet waveguide 260 (such as another optical fiber) towards a grating 218. The grating 218 spatially splits the secondary light depending on its wavelength and projects the various wavelength contributions towards a light detector 214. The light detector 214 comprises a linear array of detection elements such as photocells. In view of the spatial spreading of the different wavelengths of the secondary light (indicated schematically by an arrow and the “A” in FIG. 2) each detector element of the detector 214 can detect a different wavelength.

It should be mentioned that the various optical members shown in FIG. 2 can be substituted by other members (for instance, a prism may be used for splitting wavelengths as an alternative to a grating). Furthermore, it is possible that other optical components are provided such as lenses, collimators, etc.

Via a connection conduit 262 (which should be as short as possible and which should have an internal volume as small as possible) the fluidic sample which has been analyzed within the first flow cell 202 is introduced through a fluid inlet interface 252 of second flow cell 204. The second flow cell 204 can be configured in a similar manner as the first flow cell 202. Corresponding reference signs are used for corresponding components of the first flow cell 202 and of the second flow cell 204. However, the length of the flow path, d, of the second flow cell 204 is significantly smaller than the length of the flow path, D, of the first flow cell 202. Another grating 220 and another detector 216 detect the corresponding signals in the second flow cell 204.

As indicated schematically only for the second flow cell 204, both flow cells 202, 204 are total internal reflection (TIR) flow cells. In other words, the tubing 222 may be made of such a material that a total reflection occurs at an outer cylindrical surface of the tubing 222. Therefore, basically all electromagnetic radiation may be kept within the tubing 222, thereby further increasing the accuracy of the system. Tubing 222 may be a quartz capillary having an outer interface to air. Fluidic sample flowing through flow outlet interface 256 of the second flow cell 204 may be directed to a waste container (not shown).

As can be taken from FIG. 2, the detection signal intensities may be supplied from the detectors 214, 216 to a data determining unit 206. Data determining unit 206 in combination with a data combining unit 208 may evaluate the measurement signals captured by the detectors 214, 216 in order to derive a measurement result such as an identification of fractions of the fluidic sample based on a retention time, an estimation of the concentration of fractions of the fluidic sample, etc. The data determining unit 206 and the data combining unit 208 may be configured as separate processors or may form part of a common processor.

An input/output unit 280 may allow a user to bidirectionally communicate with the data determining unit 206 and the data combining unit 208. For instance, a user may input instructions for the data evaluation such as parameters of a weighting function to be applied. It is also possible that evaluation results from the data determining unit 206 and the data combining unit 208 are reported to the user via the input/output unit 280.

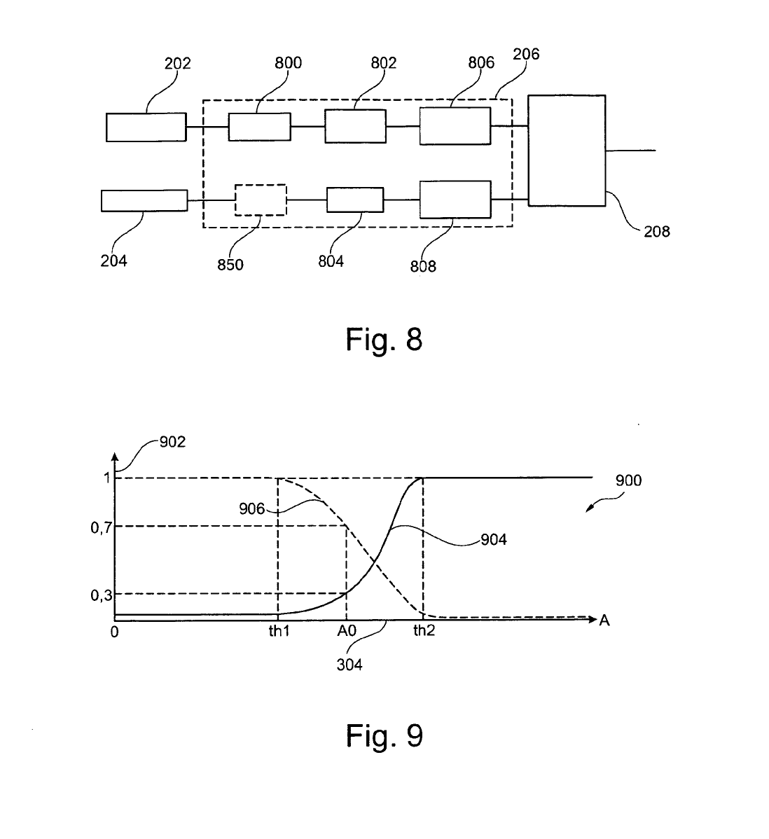

The data determining unit 206 is configured for determining first data indicative of a first relation between an absorbance and a concentration of the fluidic sample as detected by detector 214 of the first flow cell 202. Although the detector 214, in a wavelength dependent manner, detects an absorbance over time, the data determining unit 206 may process such measurement data to obtain a correlation between detection signal intensity and a concentration of the fluidic sample flowing through the first flow cell 202. This evaluation can be based on the Lambert Beer Law. In a similar way, the data determining unit 206 may determine second data indicative of a second relation between an absorbance and the concentration of the fluidic sample as detected by the detector 216 in the second flow cell 204. As will be described below in more detail particularly referring to FIG. 8, certain correction, compensation and rescaling operations may be performed by the data determining unit 206 in order to render the data from the detectors 214, 216 directly comparable. It is noted that the data determining unit 206 may evaluate the data obtained from the detectors 214, 216 in a wavelength dependent manner in a configuration in which multiple wavelengths are detected at the same time.

The first and second data as determined by the data determining unit 206 may then be supplied to data combining unit 208. The data combining unit 208 is configured for performing a weighted combination of the first data and the second data in accordance with a predetermined continuous weighting function. Hence, a weighted relation between an absorbance and the concentration of the fluidic sample is determined within the data combining unit 208 by performing, in a concentration-dependent manner, a linear combination of the results of the two detectors 214, 216. This is performed in such a manner that the weighted relation continuously reduces the contribution of the first data and therefore of the first flow cell 202 and at the same time continuously increases the contribution of the second data and therefore the influence of the second flow cell 204 with increasing concentration. The reason for this will be made plausible below referring to FIG. 3 and FIG. 7.

In other words, the data combining unit 208 puts together pieces of the first data with pieces of the second data. Hence, concentration ranges in which the first flow cell 202 has the better accuracy as compared to the second flow cell 204 may be combined with other concentration ranges in which the second flow cell 204 has the better accuracy as compared to the first flow cell 202 so as to expand the linear range along which the sample detection apparatus 200 may operate. It may use portions of the data at which the first flow cell 202 having the long path length, D, has its strength, and it may use other portions at which the second flow cell 204 having the short path length, d, has its strength. For instance, the length d may be 3.4 mm, whereas the length D may be 60 mm. The flow paths 202, 204 are serially connected. Moreover, it may combine a part of the first data with a part of the second data in a transition range at which both flow cells 202, 204 have a good accuracy. Therefore, as a result, a large linear range is obtained by the sample detection apparatus 200, i.e. the dependency between concentration of fluidic sample and the absorbance is linear over a broad range.

FIG. 3 shows a diagram 300 having an abscissa 302 along which the concentration of the fluidic sample is plotted. Along an ordinate 304, the absorbance as measured by a detector 214 or 216 is plotted. FIG. 3 shows that there is ideally a linear dependency between the absorbance and the concentration. However, at very small concentration values, as indicated schematically with reference numeral 306, the noise over the signal will be quite large because the statistical basis for determining the linear relationship between absorbance and concentration is not yet sufficient. As indicated schematically with reference numeral 308, the dependency between absorbance and concentration deviates from the linear Lambert Beer behavior at very high concentration values when saturation effects occur. As a consequence of such saturation effects, the measured curve will be below the linear curve. It is believed that such saturation effects result from stray light entering the flow cell 202 or 204 as a parasitic contribution. Between the regions 306 and 308, i.e. over an intermediate linear range 310, the corresponding flow cell shows a proper linear behavior.

FIG. 4 shows a diagram 400 illustrating similar features as diagram 300, however having an ordinate 402 along which the absorbance divided by the concentration is plotted. Thus, the linear behavior of FIG. 3 is transferred into an ideally constant behavior when the absorbance is divided by the concentration.

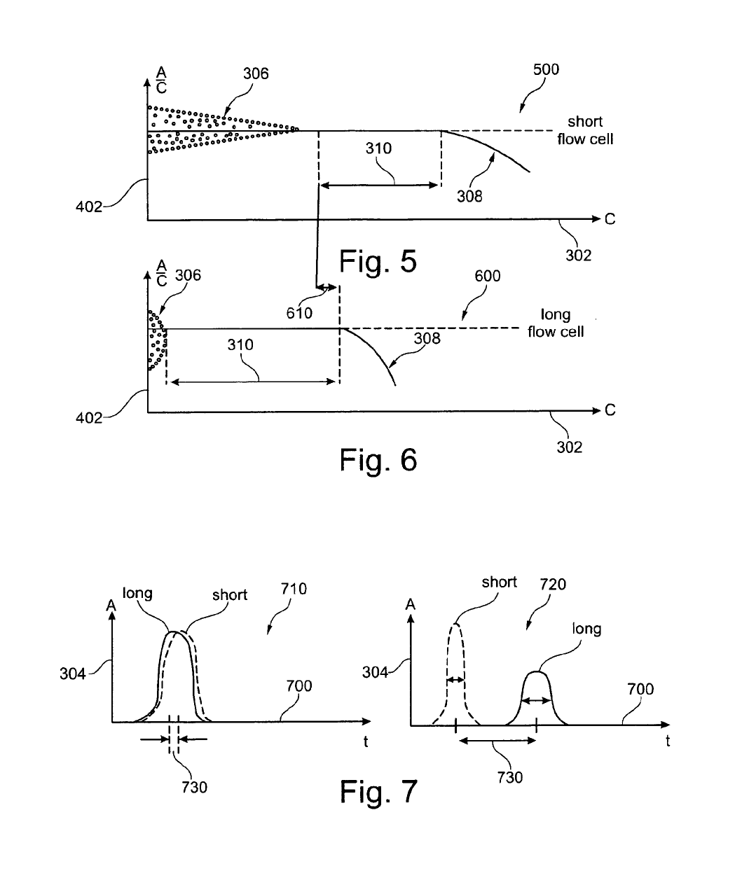

FIG. 5 shows a diagram 500 which is similar to the diagram 400 for a short flow cell such as the second flow cell 204. FIG. 6 shows a diagram 600 similar to the diagram 400, however for a long flow cell such as the first flow cell 202. This shows that the linear range 310 is shifted to higher values in FIG. 5 as compared to FIG. 6, however with some overlap 610. Since the interaction time between the fluidic sample and the light is shorter in the short flow cell 204, the noise range 306 is expanded to higher concentration values in the short flow cell 204 as compared to the long flow cell 202. Since the saturation effects resulting from strong absorption of light occur already at lower concentration values in the long flow cell 204 as compared to the short flow cell 202, the linear range 310 extends to higher values in FIG. 5 as compared to FIG. 6.

FIG. 7 shows the absorbance 304 in dependence of the time 700 in a first diagram 710 and in a second diagram 720. The first diagram 710 corresponds to an arrangement at which the long flow cell 202 is arranged upstream of the short flow cell 204, as shown in FIG. 2. In contrast to this, the diagram 720 corresponds to the inverse configuration in which the long flow cell 202 is arranged downstream of the short flow cell 204, i.e. the fluidic sample first flows through the short flow cell 204 and only subsequently through the long flow cell 202. Two effects can be seen. Firstly, a difference between retention times denoted schematically with reference numeral 730 is significantly smaller in diagram 710 as compared to diagram 720. Secondly, a full width half maximum of the two curves is more or less the same in diagram 710 but differs significantly in diagram 720. This results from the fact that a delay resulting from the fluid flowing along the flow cells is significantly more distinguished in the scenario of diagram 720 as compared to the diagram 710. Furthermore, peak broadening resulting from diffusion effects is also much more pronounced in diagram 720 as compared to diagram 710. In view of FIG. 7, it is preferred that the short cell 204 is arranged downstream of the long cell 202, as in diagram 710 and as in FIG. 2.

FIG. 8 schematically shows several tasks as performed particularly by the data determining unit 206 for processing measurement signals as detected directly by the detectors 214 and 216, respectively, of the first flow cell 202 and the second flow cell 204.

Firstly, as can be taken from FIG. 7, the measurement signals showing a relation between absorbance and measurement time supplied from the flow cells 202, 204 to the data determining unit 206 may first be corrected in terms of broadening. Slight broadening of the signal in the downstream flow cell as compared to the upstream flow cell (see diagram 710) may be compensated by filtering only the signal coming from the long upstream flow cell 202 by an infinite impulse response filter 800. Therefore, the full width half maximum values of the signals from the different flow cells are brought in accordance to one another. Alternatively, it is also possible to narrow the peak of the short cell 204, as indicated schematically by a block 850 illustrated with dotted lines. However, as an alternative to the block 850, the short cell signal may not be manipulated at all in terms of signal broadening.

Moreover, the intensity of the signals in the different flow cells 202 and 204 are usually different in view of the different lengths of the flow path. To at least partially compensate for such differences, the signals coming from the respective flow cells 202, 204 may be normalized in a normalizing block 802 and 804 to a certain value of path length. For instance, they can be normalized to a standard flow cell having a flow length of 1 cm. As an alternative to the provision of two separate normalizing blocks 802, 804, it is also possible to omit one of the blocks 802, 804 and to normalize the signal from one flow cell (202 or 204) to the length of the other flow cell (204 or 202).

Furthermore, a baseline correction block 806, 808 may be used in the data determining unit 206 so as to compensate for a signal underground (which can be approximated by a linear curve y=ax+t) and which may result from impurities in the sample or the like.

The so-formed manipulated signals may then be inserted into the data combining unit 208.

The weighting as performed in the data combining unit 208 is described referring to diagram 900 shown in FIG. 9. Along an ordinate 902, a contribution of the absorbance signal of the second flow cell 204 to an output signal of the data combining unit 208 is indicated with a reference numeral 904, whereas a contribution of the absorbance signal of the first flow cell 202 to the output signal of the data combining unit 208 is indicated with a reference numeral 906. In other words, the data combining unit 208 combines the first data and the second data as output by the data determining unit 206 to derive a weighted relation by exclusively using the first data and disregarding the second data below a lower threshold absorbance value th1. Above an upper threshold absorbance value th2, only the second data is used, and the first data is disregarded. Between th1 and th2, both data are used in a weighted manner with the data 906 decreasing in importance and the data 904 increasing in importance with increasing absorbance (and consequently concentration) values. It can be seen in FIG. 9 that the transition of the curves 904, 906 particularly at the first threshold value th1 and at the second threshold value th2 is smooth, i.e. shows a continuous behavior and is differentiable at these absorbance values as well. This allows to obtain an artifact-free estimation of the absorbance value also around th1 and th2. However, other embodiments of the invention may use other weighting methods.

As an example, an absorbance value may be A₀. A₀ may be a measured and processed absorbance value obtained from the flow cells 202 and/or 204, for instance an average value or a reference value. At this value A₀ of the absorbance, the weighting function of FIG. 9 indicates that 70% of the signal of flow cell 202 and 30% of the signal of flow cell 204 will be used for determining the concentration.

It should be emphasized that the weighting function, as the one which can be derived from FIG. 9, depends on the wavelength. Hence, for a different wavelength, the upper threshold value th2, the lower threshold value th1 and the width of the linear region may be different. Thus, the introduction of a weighting function is particularly appropriate for multi-lambda detection systems because a linear behavior is particularly of importance in such arrangements.

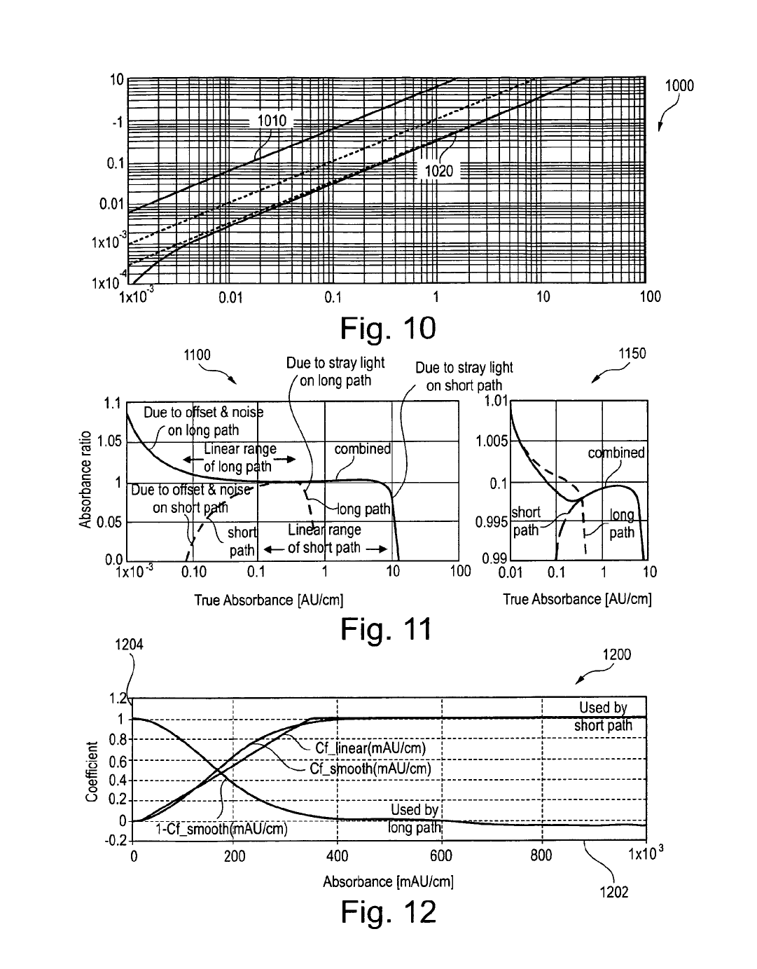

In the following, referring to FIG. 10 to FIG. 23, a more detailed exemplary embodiment of the invention will be explained.

According to an exemplary embodiment of the invention, two diode array detectors with flow cells having different path lengths are serially connected in a liquid chromatography device. The components of a sample separated by a separation column sequentially pass the two flow cells of the hydraulically serially connected flow cells. The cell of the one detector has a longer path length than the cell of the other detector. Hence, the detector having the long path length is capable of performing very sensitive measurement and of detecting also very small changes in concentration. In other words, it is possible to measure also very small amounts of a substance in the sample. On the other hand, the detector with the short path length is also capable to measure samples with very high concentrations (Lambert Beer Law).

A detector of a given path length covers a certain usable absorption region. This absorption region gives, for a given substance, a corresponding range of concentrations. A lower absorption region is limited by noise and possible fluctuations on the baseline, and is limited to an upper concentration by the influence of stray light. This contribution, also denoted as false light, results from spectral contributions deviating from a measurement wavelength which are superposed with the selected wavelength. This results in non-linear behavior in an upper region of absorption values, since these spectral contributions of the light show an extinction, i.e. absorption capability of a certain substance component, deviating from the measurement wavelength.

In order to cover a sufficiently large concentration range with two detectors of flow cells, an exemplary embodiment of the invention uses a detector with a large cell (large path length) in order to cover the lower absorption range as accurate as possible. This is combined with a second detector and a short cell (short path length) in order to add the upper absorption range.

For the selection of a proper path length for both flow cells it is considered to be important that the usable concentration ranges overlap under consideration of the respective limitations. Under these circumstances, it is reasonable to combine the signals of both detectors by means of a suitable calculation rule so that a common combined signal is formed. This signal now has the properties of the signal with the large path length in a lower to medium concentration range. The properties of the signal with the short path length are used for the upper concentration range. As already mentioned, there may be an overlapping range in a medium (or central) concentration region in which the signals of both detectors can be used.

According to an exemplary embodiment of the invention, both signals can be used and an appropriate unique calculation rule may be used for combining both signals in such a manner that the resulting signal shows properties as if the limitations of the detector with the large path length in its upper concentration range as well as the limitations of the detector having the short cell are eliminated. As a result, a usable concentration range is obtained which is increased by the path length ratio of both detectors.

FIG. 10 illustrates such conditions by plotting an absorbance characteristic on a log-log scale in a diagram 1000. Reference numeral 1010 indicates an ideal and a real signal on the long path, whereas reference numeral 1020 shows an ideal and a real signal on a short path.

Furthermore, FIG. 11 shows a first diagram 1100 and a second diagram 1150, wherein the first diagram 1100 plots a transition range of combining both signals. The diagram 1150 shows the transition range in a zoomed illustration. Hence, FIG. 11 again plots the expanded linear range with the limitations of both detectors.

According to an exemplary embodiment of the invention, a calculation rule for signal combining takes into account that the influences of the serial coupling of the two detectors on the signals can be advantageously compensated. By the volume of the flow cells and the required connection capillaries, the concentration dependencies in both flow cells may differ in time, so that one signal will appear to be delayed with regard to the other one. Furthermore, the peak shape can be influenced due to the effect of diffusion. In order to obtain correct results, it is advantageous to consider such circumstances in the calculation of a combined signal.

Next, consideration of the delay of the concentration distribution will be discussed.

The delay of the concentration dependency of the downstream flow cell as compared to the upstream flow cell depends on the geometric conditions of the flow cells and the connection capillary. It is inversely proportional to the flow rate (flowing fluid volume per time interval). A delay factor being dependent on the flow rate can be determined experimentally. The compensation of the signals occurring earlier in time at the upstream detector can be performed based on the knowledge of the present flow rate.

In the following, the influence of diffusion on the peak shape will be discussed.

The influence of diffusion on the peak shape occurs in the form of a broadening of a peak. Such a broadening can be modeled in proper approximation by manipulating or processing the signal of the upstream detector by means of an infinite impulse response (IIR) filter.

By taking this measure, it is possible to at least partially compensate the temporal delay of a signals and the broadening of the peak shape in good approximation.

Now it is necessary to combine both signals in an appropriate manner to a resulting signal which can then be supplied to the further processing. In a first process, the signals of both detectors can be normalized to a unique path length (for instance 1 cm). Then both signals can be added using a weighting function. The weighting function can be oriented on the mutual overlapping range in which both detectors operate in a linear range. In this region, the values of the normalized signals of both detectors are identical, except for system specific deviations.

FIG. 12 shows a diagram 1200 in which a weighting function for combining signals from both flow paths is plotted. Along an abscissa 1202, nominal absorbance is displayed, whereas a coefficient indicative of the weighting function is displayed along an ordinate 1204.

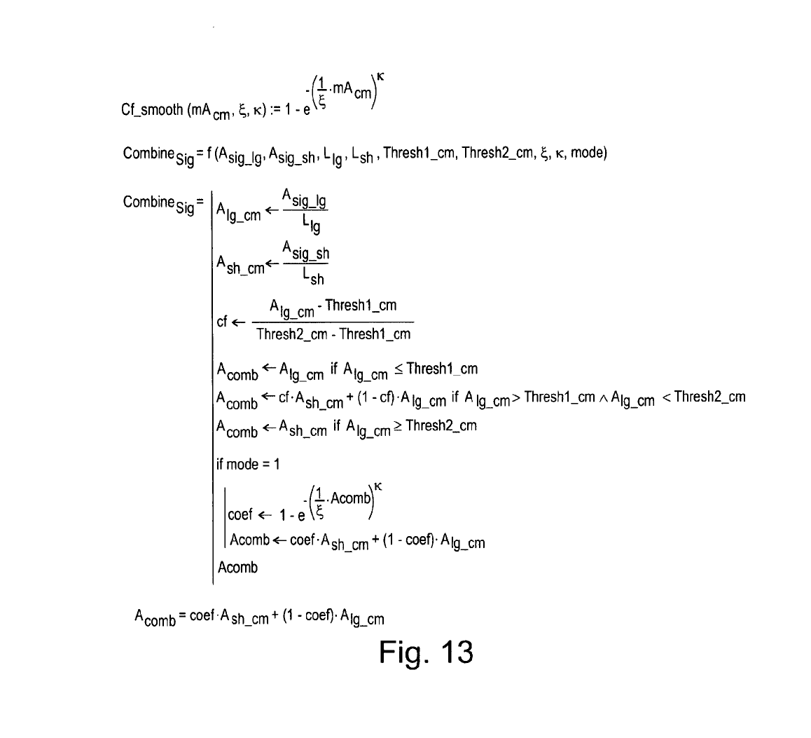

FIG. 13 shows a coefficient Cf_smooth(mA_{cm}, ξ, κ) of the weighting function as well as a calculation rule for the signal combination. κ is a parameter having an influence on the steepness of the curve shown in FIG. 12. ξ is a parameter having an influence on the position of the 50% point at which the contributions of both flow cells is identical. mA_{cm} denotes the nominal absorbance. The value of the coefficient of the weighting function is between 0 and 1.

This results in a calculation rule (function f) for the combination (Combine) of the two pre-processed signals. This can be taken from FIG. 13 as well. Here, A denotes an absorbance corresponding to a signal sig, L denotes a corresponding path length, Thres stands for a corresponding threshold value, lg for long, sh for short, and mode for a corresponding parameter.

This means that the signal of the detector with the long path length dominates in the range of lower concentration values, whereas in an upper range of concentration values exclusively the signal of the detector with the shorter path length is used. In an intermediate range, the weighting function provides for a continuous or smooth transition.

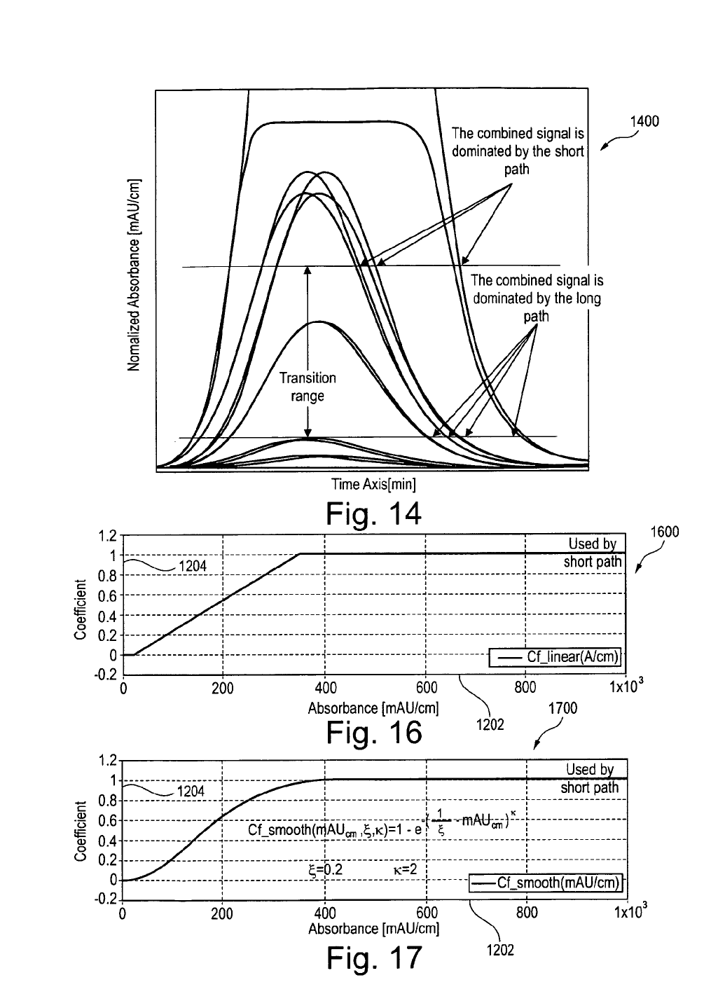

FIG. 14 shows a diagram 1400 which illustrates this situation in further detail. FIG. 14 plots signals of the short path, signals of the long path, and a combined signal.

In the following, the handling of the weighting function will be described.

The shown coefficient of the weighting function Coef=f(Absorbance/cm) relates to a normalized absorbance axis [mAU/cm]. This axis basis can be estimated in a simple case so that up to a certain threshold value, the normalized signal of the long cell is used, and from the selected threshold value onwards the normalized signal of the short cell is used. The threshold value is here referred to the normalized signal of the long cell and is selected in such a manner that the long cell operates in the linear region.

However, using such an approach can cause an abrupt transition during the formation of a combined signal, the basis of the absorption axis can show gaps, or axis sections may overlap. Such effects may be caused by additive error terms in form of offset or drift of the corresponding signals.

In view of these considerations, a significantly improved method for the forming of an absorbance axis basis is a continuous transition within two selected threshold values. This method according to an exemplary embodiment of the invention corresponds to a first approximation of the weighting function. In other words, the axis basis is formed below the first threshold value from a 100% contribution of the signal from the detector with the long cell and above the threshold value from a 100% contribution of the signal of the detector with the short path length. Between these threshold values, the axis basis is formed by the weighted addition of both normalized signals, wherein the weighting for the signal with the long path length runs linear from 1 to 0, and in an inverse manner, the weighting for the signal with the short path length goes from 0 to 1.

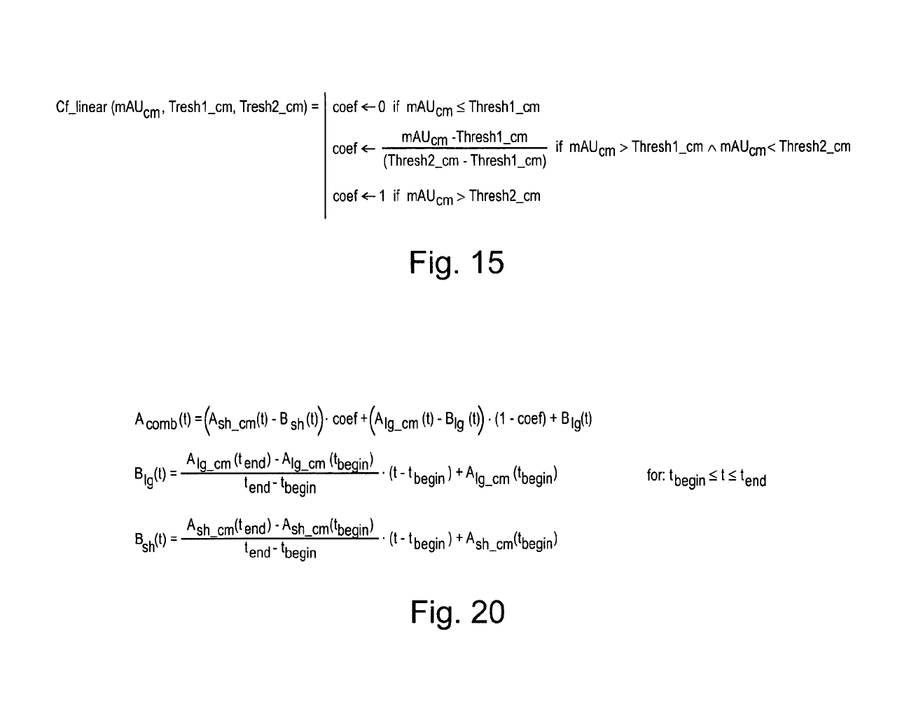

A corresponding calculation rule is indicated schematically in FIG. 15. A coefficient of a corresponding weighting function is shown in a diagram 1600 shown in FIG. 16. With such an axis basis, the actual weighting with the presented weighting function is then performed in accordance with a diagram 1700 shown in FIG. 17.

Such an additional process is advantageous because a continuous transition of the normalized signal of the long cell to the normalized signal of a short cell can be realized by this. By the parameters ξ and κ, the weighting function can be adapted to the preferences of a user. The parameter ξ defines the position of the transition and the parameter κ defines the slope of the transition. For instance, a reasonable value is ξ=0.2 and κ=2. More generally, a reasonable range for χ is 0.05 to 0.5, particularly 0.1 to 0.3. A reasonable range for κ is 1 to 5, particularly 1.5 to 3.

By taking these measures, a simultaneous extension of the linear range at extraordinary sensitivity is possible. The extraordinary sensitivity allows for a low level impurity detection, and the baseline noise can be <1 μAU/cm. The linear range can be extended. The usable linear range can be larger than 6 decades. Absorbance can be up to 8 AU/cm. All applications of a 60 mm flow cell can be matched. There will be no extra peak dispersion.

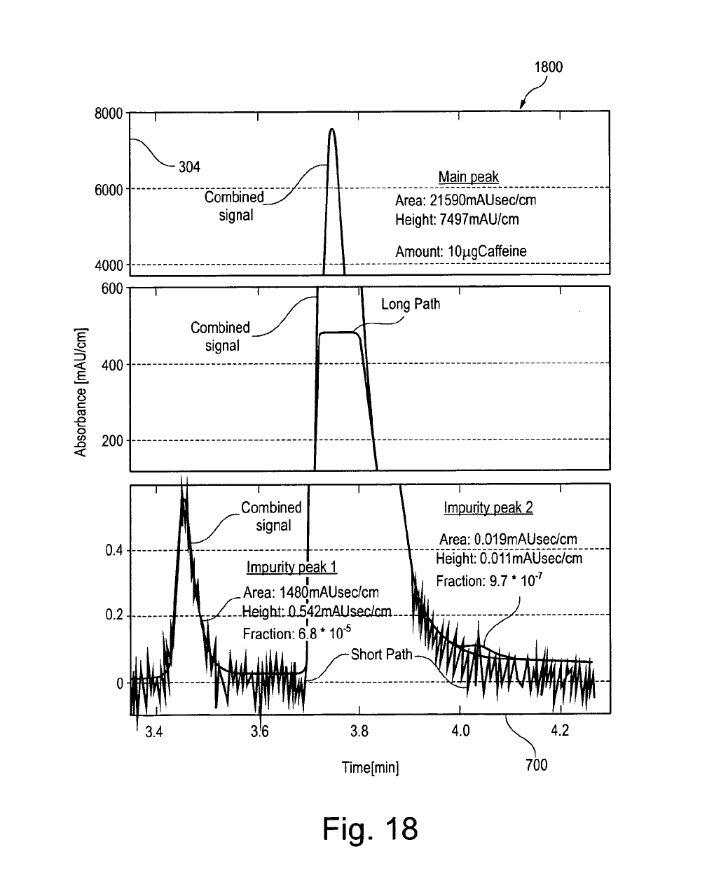

FIG. 18 shows a diagram 1800 in which peaks are illustrated with its absorbance-time characteristic. FIG. 18 shows short path signals, long path signals, and combined signals.

In order to further refine the evaluation of the data, it is possible to perform the weighting under consideration of an influence of a baseline offset and/or drift.

Hence, a further consideration for the calculation of a combined signal is that, under undesired circumstances, it can happen that the signals of the baseline of both detectors drift away from one another. This can result from the influences of changes of the refraction index or other influence factors of other physical or chemical parameters. In such cases, the values of the normalized signals of both detectors can deviate from one another to a relevant extent. Since the measurement values are overlaid in such cases by terms being not proportional to the path lengths, this may result in artifacts in the weighted addition of the normalized signals.

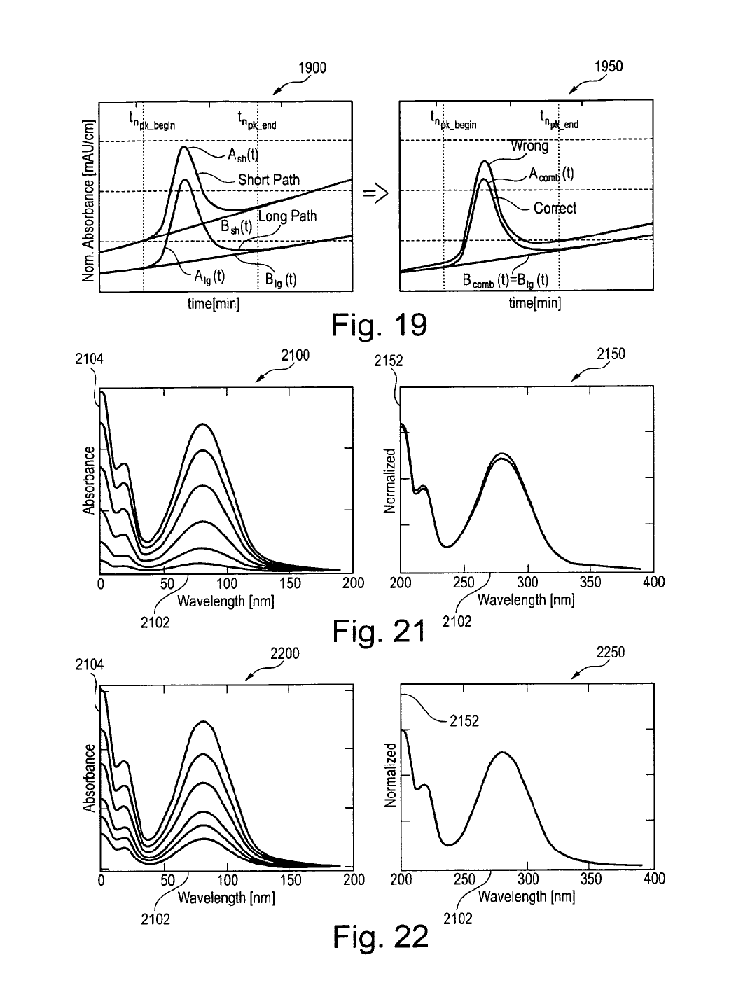

FIG. 19 makes this issue clear. Without the corresponding compensation of the deviating baseline sequences, the calculation may result in an erroneous signal. A diagram 1900 shows the scenario for a short path and a long path, whereas a diagram 1950 shows the situation for a combined signal.

Under consideration of these facts this means that for calculating the combined signal with high accuracy, it is advantageous to add, to the baseline B_{lg}(t) of the signal of the detector with the long path length, the weighted portions of the baseline corrected peaks. For this purpose, it is required to know the beginning of the peak t_{begin} and the end of the peak t_{end}. FIG. 20 shows a corresponding calculation rule. Here, B denotes the baseline signal.

In the following, further issues in connection with the calculation of absorption spectra will be discussed.

There should be a focus on the calculation of the spectra over the width of the peak. The requirements of the calculation of the spectra in relation to linearity over a wide concentration range are challenging.

The monitoring or verification of the purity of a peak by comparing spectra over a concentration range requires a linear behavior not only over the width of the signal at the selected measurement wavelength but in addition also over the observed spectral range of the corresponding substance.

In cases in which the concentration range of the peaks covers the complete linear absorption range, non-linearities may occur in the spectral regions at which the extinction coefficient of the substance is higher than at the measurement wavelength. Selecting the measurement wavelength may be based on other criteria as for the definition of the spectral range. The measurement wavelength can be selected to be within the apex of an absorption band in order to obtain a high accuracy in view of the high extinction coefficient, and on the other side to be insensitive to the influence of spectral deviations.

For a reliable identification of a substance it may be required to have a sufficiently broad spectrum, since this allows to obtain pronounced features. For the monitoring of the purity of a substance under the concentration dependency similar considerations apply. In many cases, the usable spectral range can be limited by non-linearities in the regions of high extinction coefficients.

FIG. 21 shows a diagram 2100 having an abscissa 2102 along which the wavelength is plotted and having an ordinate 2104 along which the absorbance is plotted. The diagram 2100 shows a spectral over peak behavior. A corresponding diagram 2150 has an ordinate 2152 along which a normalized absorbance is plotted so that diagram 2150 shows normalized spectra over peak.

By applying the mentioned method, the discussed limitations can be limited and/or suppressed by a significant degree. This allows to obtain reliable results of the analysis and quantification of samples to be investigated.

FIG. 22 shows a diagram 2200 (corresponding to diagram 2100) and a diagram 2250 (corresponding to diagram 2150) obtained by using the discussed method.

As can be taken from the normalized spectra, the spectra are identical over the whole range of the peaks.

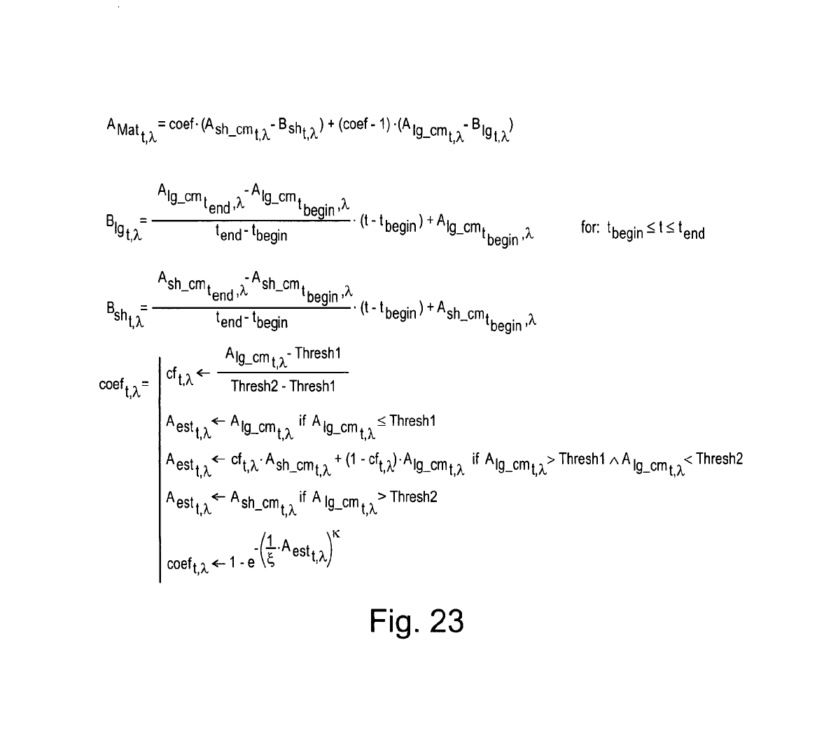

The calculation rule for the calculation of the resulting matrix over the time and wavelength axis is shown in FIG. 23.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A sample detection apparatus for detecting a fluidic sample flowing through a first flow cell and flowing through a second flow cell of a sample separation system, wherein the first flow cell has a first path length (D) and the second flow cell has a second path length (d) being smaller than the first path length (D), the sample detection apparatus comprising:
a data determining unit configured for determining first data indicative of a first relation between a detection signal intensity and a concentration of the fluidic sample in the first flow cell, and configured for determining second data indicative of a second relation between a detection signal intensity and the concentration of the fluidic sample in the second flow cell; and
a data combining unit configured for combining the first data and the second data in accordance with a continuous weighting function to thereby derive a weighted relation between detection signal intensity and concentration of the fluidic sample so that the weighted relation continuously reduces the contribution of the first data and continuously increases the contribution of the second data with increasing concentration.

2. The sample detection apparatus according to claim 1, wherein the data combining unit is configured for combining the first data and the second data in accordance with a continuous differentiable weighting function.

3. The sample detection apparatus according to claim 1, wherein the data combining unit is configured for combining the first data and the second data to derive the weighted relation by:
exclusively using the first data and disregarding the second data below a lower threshold value of the detection signal intensity,
exclusively using the second data and disregarding the first data above an upper threshold value being larger than the lower threshold value of the detection signal intensity,
using both the first data and the second data in accordance with the weighting function between the lower threshold value and the upper threshold value,
so that the weighted relation is continuous and shows a smooth transition, both at the lower threshold value and at the upper threshold value.

4. The sample detection apparatus according to claim 1, wherein the data determining unit is configured for determining the first data based on a first measurement signal received from the first flow cell and is configured for determining the second data based on a second measurement signal received from the second flow cell, the respective measurement signal being indicative of a relation between detection signal intensity and measurement time in the respective flow cell.

5. The sample detection apparatus according to claim 4, wherein the data determining unit comprises a configuration selected from the group consisting of:
the data determining unit is configured for determining the respective data based on an evaluation of secondary electromagnetic radiation measured from the fluidic sample in response to the irradiation of the fluidic sample with primary electromagnetic radiation, the measured secondary electromagnetic radiation constituting the measurement signal received from the respective flow cell;
the data determining unit is configured for adding a delay selectively to the measurement signal of the first flow cell or is configured for subtracting a delay selectively from the measurement signal of the second flow cell for at least partially compensating a measurement signal delay in the second flow cell as compared to the first flow cell;
the data determining unit is configured for selectively broadening the measurement signal of the first flow cell or is configured for selectively narrowing the measurement signal of the second flow cell for at least partially compensating a measurement signal broadening in the second flow cell as compared to the first flow cell;
the data determining unit is configured for scaling the measurement signals of the first flow cell and of the second flow cell relative to one another for at least partially compensating the different path lengths (D, d) in first flow cell and in the second flow cell;
the data determining unit is configured for performing a baseline correction for at least partially removing signal underground in the measurement signals of the first flow cell and of the second flow cell; and
a combination of two or more of the foregoing.

6. The sample detection apparatus according to claim 5, wherein the data determining unit is configured for determining the respective data based on an evaluation of secondary electromagnetic radiation measured from the fluidic sample in response to the irradiation of the fluidic sample with primary electromagnetic radiation, the measured secondary electromagnetic radiation constituting the measurement signal received from the respective flow cell, and wherein the data determining unit is configured for determining the respective data individually for different measurement wavelengths of the secondary electromagnetic radiation.

7. The sample detection apparatus according to claim 6, wherein the data combining unit is configured for combining the first data and the second data in accordance with a wavelength-dependent weighting function being different for different measurement wavelengths of the secondary electromagnetic radiation.

8. (canceled)

9. The sample detection apparatus according to claim 4, wherein the data determining unit is configured for adding a delay selectively to the measurement signal of the first flow cell or is configured for subtracting a delay selectively from the measurement signal of the second flow cell for at least partially compensating a measurement signal delay in the second flow cell as compared to the first flow cell, and wherein the data determining unit is configured for adding or subtracting the selective delay in accordance with the flow rate of the fluidic sample.

10. (canceled)

11. The sample detection apparatus according to claim 4, wherein the data determining unit is configured for selectively broadening the measurement signal of the first flow cell or is configured for selectively narrowing the measurement signal of the second flow cell for at least partially compensating a measurement signal broadening in the second flow cell as compared to the first flow cell, and wherein the data determining unit comprises a filter, for performing the selective broadening.

12. (canceled)

13. The sample detection apparatus according to claim 4, wherein the data determining unit is configured for scaling the measurement signals of the first flow cell and of the second flow cell relative to one another for at least partially compensating the different path lengths (D, d) in first flow cell and in the second flow cell, and wherein the data determining unit is configured for scaling the measurement signals of the first flow cell and of the second flow cell relative to one another by normalizing the measurement signals to a predefined normalized path length.

14. (canceled)

15. The sample detection apparatus according to claim 14, wherein the data determining unit is configured for performing a baseline correction for at least partially removing signal underground in the measurement signals of the first flow cell and of the second flow cell, and wherein the data determining unit is configured for performing the baseline correction for the first and the second flow cell by individually determining a respective function, for modeling signal underground for the respective measurement signals and by subtracting the respective function from the respective measurement signal.

16. The sample detection apparatus according to claim 1, wherein the detection signal intensity is indicative of an absorption of electromagnetic radiation, propagating along the respective flow cell over the respective path length (D, d), by the fluidic sample.

17. The sample detection apparatus according to claim 1, further configured for detecting the fluidic sample flowing through a third flow cell which has a third path length different from the first path length (D) and the second path length (d),
wherein the data determining unit is configured for determining third data indicative of a third relation between a detection signal intensity and the concentration of the fluidic sample in the third flow cell; and
wherein the data combining unit is configured for combining the first data and the second data and the third data in accordance with the continuous weighting function.

18. The sample detection apparatus according to claim 1, wherein the weighting function has a contribution for the first flow cell of exp (−A/ξ)^{K} and has a contribution for the second flow cell of 1−exp (−A/ξ)^{K}, wherein A is the nominal absorbance, ξ defines an absorbance value at which the contribution of the first flow cell equals to the contribution of the second flow cell, and κ is a parameter which defines a slope of the weighting function.

19. A sample separation system for separating components of a fluidic sample, the sample separation system comprising;
a separation unit configured for separating the fluidic sample into the components;
a first flow cell in fluid communication with the separation unit for receiving separated sample fluid from the separation unit, wherein the first flow cell has a first path length (D);
a second flow cell in fluid communication with the separation unit for receiving separated sample fluid from the separation unit, wherein the second flow cell has a second path length (d) being smaller than the first path length (D); and
a sample detection apparatus according to claim 1 configured for detecting the separated components.

20. The sample separation system according to claim 19, wherein the second flow cell is arranged downstream of and in fluid communication with the first flow cell for receiving the separated sample fluid from the first flow cell.

21. The sample separation system according to claim 19, comprising a feature selected from the group consisting of:
the first path length (D) is larger than 15 mm and the second path length (d) is smaller than 8 mm;
the first path length (D) is in a range between 10 mm and 100 mm;
the first path length (D) is in a range between 30 mm and 80 mm;
the second path length (d) is in a range between 1 mm and 9 mm; and
the second path length (d) is in a range between 2 mm and 5 mm.

22.-23. (canceled)

24. The sample separation system according to claim 19 or any one of the above claims, comprising at least one of the following features:
the sample separation system comprises a respective electromagnetic radiation source for each of the first and the second flow cell, the respective electromagnetic radiation source being configured for generating primary electromagnetic radiation for irradiating the fluidic sample in the respective flow cell;
the sample separation system comprises a respective electromagnetic radiation source for each of the first and the second flow cell, the respective electromagnetic radiation source being configured for generating one of an optical light beam and an ultraviolet beam as primary electromagnetic radiation for irradiating the fluidic sample in the respective flow cell;
the sample separation system comprises a respective electromagnetic radiation source for each of the first and the second flow cell, the respective electromagnetic radiation source being configured for generating polychromatic primary electromagnetic radiation for irradiating the fluidic sample in the respective flow cell;
the sample separation system comprises a respective electromagnetic radiation source for each of the first and the second flow cell, the respective electromagnetic radiation source being configured for generating primary electromagnetic radiation for irradiating the fluidic sample in the respective flow cell and being configured as one of the group consisting of a deuterium lamp, a xenon lamp, and a tungsten lamp;
the sample separation system comprises a respective electromagnetic radiation detector for each of the first and the second flow cell, wherein the respective electromagnetic radiation detector comprises one of an optical light detector, and an ultraviolet radiation detector;
the sample separation system comprises a respective electromagnetic radiation detector for each of the first and the second flow cell, wherein the respective electromagnetic radiation detector comprises one of a single detection element, a linear array of detection elements, and a two-dimensional array of detection elements;
the sample separation system comprises a respective electromagnetic radiation detector for each of the first and the second flow cell, wherein the respective electromagnetic radiation detector comprises an electromagnetic radiation sensitive unit and a grating between the flow path of the fluidic sample and the electromagnetic radiation sensitive unit;
each of the first flow cell and the second flow cell is configured as a total internal reflection flow cell;
each of the first flow cell and the second flow cell is configured as a total internal reflection flow cell, wherein a tubing, along which the fluidic sample flows in the respective flow cell, and an electromagnetic radiation source, irradiating the fluidic sample flowing in the respective flow cell, are arranged and configured for effecting a total reflection of the electromagnetic radiation at an outer wall of the tubing;
each of the first flow cell and the second flow cell is configured to conduct the fluidic sample with a high pressure;
each of the first flow cell and the second flow cell is configured to conduct the fluidic sample with a pressure of at least 50 bar;
each of the first flow cell and the second flow cell is configured to conduct the fluidic sample with a pressure of at least 100 bar;
each of the first flow cell and the second flow cell is configured to conduct the fluidic sample with a pressure of at least 500 bar;
each of the first flow cell and the second flow cell is configured to conduct the fluidic sample with a pressure of at least 1000 bar;
each of the first flow cell and the second flow cell is configured to conduct a liquid sample;
each of the first flow cell and the second flow cell is configured as a microfluidic flow cell;
each of the first flow cell and the second flow cell is configured as a nanofluidic flow cell;
the sample separation system comprises a fluid drive configured to drive the fluidic sample through the sample separation system;
the separation unit comprises a chromatographic column;
the sample separation system comprises a sample injector configured to introduce the fluidic sample fluid into a mobile phase;
the sample separation system comprises a collection unit configure to collect separated compounds of the fluidic sample;
the sample separation system comprises a degassing apparatus for degassing a mobile phase or the fluidic sample;
the separation unit is configured for retaining the fluidic sample being a part of a mobile phase and for allowing other components of the mobile phase to pass the separation unit;
at least a part of the separation unit is filled with a separating material;
at least a part of the separation unit is filled with a separating material, wherein the separating material comprises beads having a size in the range of 1 μm to 50 μm;
at least a part of the separation unit is filled with a separating material, wherein the separating material comprises beads having pores having a size in the range of 0.02 μm to 0.03 μm;
the sample separation system is configured to analyze at least one physical, chemical and/or biological parameter of at least one compound of the fluidic sample;
the sample separation system comprises at least one of the group consisting of a device for chemical, biological and/or pharmaceutical analysis, a capillary electrophoresis device, a liquid chromatography device, and an HPLC device.

25. A method of detecting a fluidic sample flowing through a first flow cell and flowing through a second flow cell of a sample separation system, wherein the first flow cell has a first path length (D) and the second flow cell has a second path length (d) being smaller than the first path length (D), the method comprising:
determining first data indicative of a first relation between a detection signal intensity and a concentration of the fluidic sample in the first flow cell;
determining second indicative of a second relation between a detection signal intensity and the concentration of the fluidic sample in the second flow cell; and
combining the first data and the second data in accordance with a continuous weighting function to thereby derive a weighted relation between detection signal intensity and concentration of the fluidic sample so that the weighted relation continuously reduces the contribution of the first data and continuously increases the contribution of the second data with increasing concentration.

26. The method according to claim 25, comprising at least one of:
the weighting function is selected under consideration of the boundary condition that noise-based artifacts being larger than a predetermined threshold value occur in the first flow cell only at lower concentrations than in the second flow cell;
the weighting function is selected under consideration of the boundary condition that saturation-based artifacts resulting from stray radiation and being larger than a predetermined threshold value occur in the first flow cell already at lower concentrations than in the second flow cell; and
the first path length (D) and the second path length (d) are selected so that a range of concentration values of the fluidic sample over which the first flow cell shows a linear relation between detection signal intensity and concentration of the fluidic sample overlaps with another range of concentration values of the fluidic sample over which the second flow cell shows a linear relation between detection signal intensity and concentration of the fluidic sample.

27.-29. (canceled)
